(19) United States
(12) Patent Application Publication
(10) Pub. No.: US 2016/0059269 A1
(43) Pub. Date: Mar. 3, 2016

(54) Self-cleaning plumbing fixture

(71) Applicant: Andrew Ronding, Mankato, MN (US)

(72) Inventor: Andrew Ronding, Mankato, MN (US)

(21) Appl. No.: 14/341,835

(22) Filed: Sep. 2, 2014

(51) Int. Cl. B08B 1/00; B08B 9/04

(52) U.S. Cl. CPC B08B 1/002; B08B 9/04

(57) ABSTRACT

A device that, when built into a traditional plumbing fixture like a sink, bathtub, or toilet, will clean that fixture automatically without the owner needing to manually clean it or use harsh chemicals to clean it.

I hereby claim I invented a plumbing fixture that cleans itself using a mechanical arm covered with brushes that runs along a track on the fixture. As such I seek a patent for the purpose of protecting my invention from unauthorized reproduction.

### BACKGROUND OF THE INVENTION

Cleaning plumbing fixtures is an unpleasant task that people must do manually using harsh chemicals. This hurts the environment and the person, especially if they have health problems. For toilets specifically, some people don't clean it manually at all but use chemical compounds that release over time but those are even harsher than those used manually.

My design is the only one if its kind, it uses a rigid arm that moves along a track on the inside of the fixture allowing it to clean the on a schedule or on command without the owner needing to work. Cleaning more often limits the need for harsh chemicals and the brushes do a better job of scrubbing than people bypassing the need for harsh chemicals or tedious labor, it does have a tank for mild soap desired.

### DESCRIPTION OF DRAWINGS

For my drawings I've used a toilet but a sink or bathtub could also be fitted with my device.

FIG. 1 shows a toilet from the side with my device built in, the majority of the device's components are inside the basin normally until the electronics are activated which push the brushes and mechanical arm along the interior of the toilet.

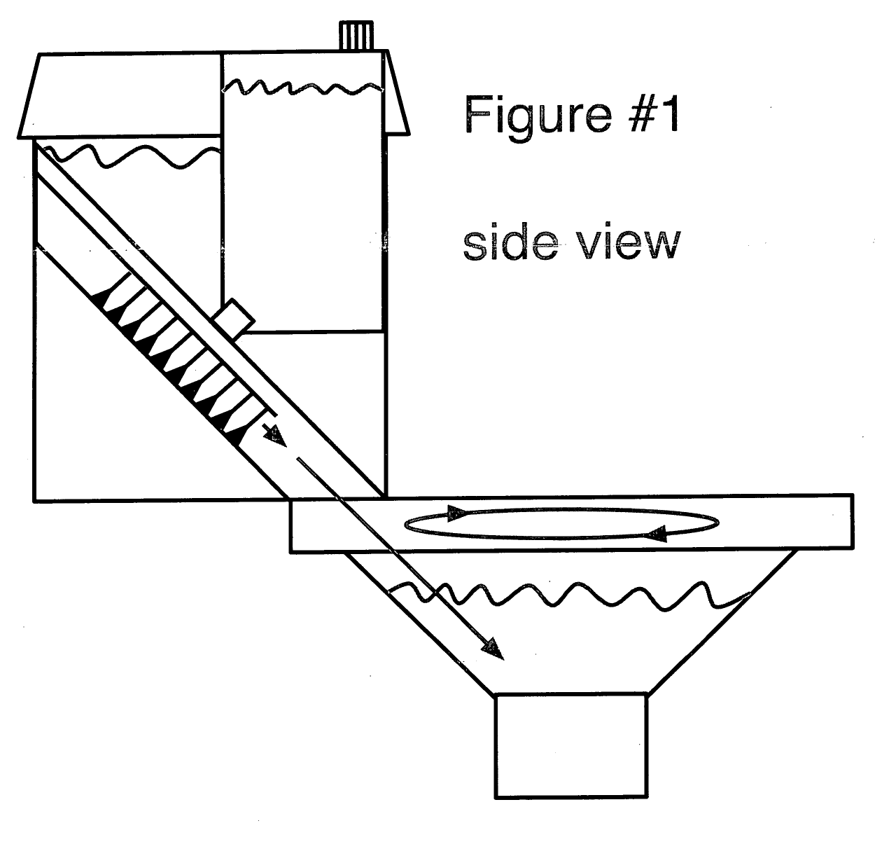

FIG. 2 is of the same toilet viewed from the front and is included to avoid any confusion on the compactness of the device. The internal mechanism of every toilet would still be present but were not included in the drawings for the sake of simplicity.

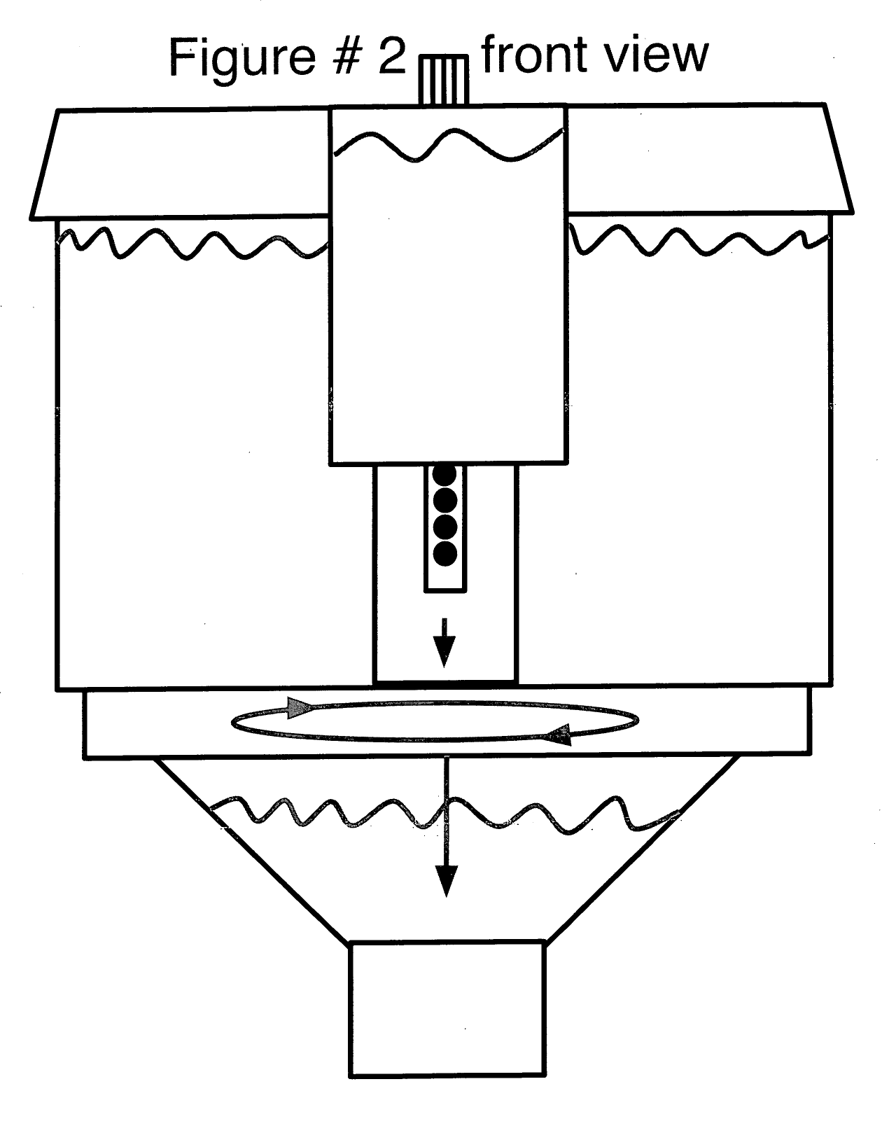

### DESCRIPTION OF FUNCTION

The brush heads are attached to the motor and fed soap and water by the tube which is all connected to the arm. The tube connects to the water source and the soap's controlling valve which is fed soap from the container. The arm is attached to a motor which moves it along a track that runs along the interior of the plumbing fixture. When not in use the arm returns to dry in its containment casing. All of these functions are controlled by the computer.

The end user would only need to fill the soap container and push the button or communicate with the computer to schedule cleanings to start the arm following the track while the brushes are spun and fed soap which cleans the fixture. When the arm reaches the end of the track the soap feed is cut off and the rinsing process begins as the arm retraces its path back to the containment casing where it started off. As it is returning the brushes will continue to spin only receiving water. In the containment casing the device will be able to dry off.

Additional elements may be added, such as UV lights in the casing to sterilize the brushes and arm, connectivity for the computer so that someone can remotely control the unit, it could be modified to use steam instead of water and soap, or for toilets a pressure sensor could be added to tell if the lid is down.

1. I, Andrew Ronding, hereby claim I invented a plumbing fixture that cleans itself using a mechanical arm covered with brushes that runs along a track on the fixture. As such I seek a patent for the purpose of protecting my invention from unauthorized reproduction.
